(19) United States
(12) Patent Application Publication
(10) Pub. No.: US 2006/0113176 A1
(43) Pub. Date: Jun. 1, 2006

(54) Electronic apparatus including operation button

(75) Inventors: Daisuke Shimizu, Echizen-city (JP); Hidenobu Mukougawa, Echizen-city (JP); Takayuki Horie, Echizen-city (JP); Yasuo Mitomori, Echizen-city (JP); Tsuyoshi Yoshida, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/282,840

(22) Filed: Nov. 21, 2005

(30) Foreign Application Priority Data
Nov. 26, 2004 (JP) 2004-342534

(51) Int. Cl. H01H 13/70

(52) U.S. Cl. 200/343

(57) ABSTRACT

To make it possible to prevent static electricity from being accumulated in operation buttons and surely prevent static electricity from being discharged to circuit components inside a case from the operation buttons. A conductive chassis 3 and a printed board 5 mounted with a tact switch 4 are arranged inside a case 2. An operation button 10 for operating the tact switch 4 includes operating sections 11, an engaging hook 17 that engages with an engaging hole 16, and an elastically deformable contact piece 19 integrally formed from the center at a lower end of the operation button via a thin hinge section 18. The operation button 10 is assembled with the button frame 15 and fixed to the case 2. The contact piece 19 elastically comes into contact with the chassis 3 in this state and static electricity accumulated in the operation button 10 flows to the chassis 3.

The present application is based on and claims priority of Japanese patent application No. 2004-342534 filed on Nov. 26, 2004, the entire contents of which are hereby incorporated by reference.

### BACKGROUND OF THE INVENTION

1. Field of the Invention

The present invention relates to an electronic apparatus including a substrate provided inside a case, switches mounted on the substrate, and operation buttons for operating to press the switches from the outside of the case. In particular, the invention relates to an electronic apparatus including operation buttons that is constituted to prevent static electricity from being accumulated in operation buttons.

2. Description of the Related Art

Conventionally, in electronic apparatuses, plural operation buttons for operating the electronic apparatus are provided. In order to improve decorativeness as such operation buttons, among operation buttons formed of resin, there is known an operation button, a surface of which is plated. Static electricity tends to be accumulated in such an operation button, a surface of which is plated. As measures against the static electricity, Japanese Patent Laid-open Publication No. 2002-150879 (patent document 1) discloses an electronic component that has operating sections operable to be pressed from the outside of a case and elastic sections elastically deformable by pressing operation of the operating sections, includes a support section that support the operating sections on one end side of the elastic sections, and is constituted to prevent static electricity from being accumulated in the operation buttons by bringing an earth section formed in the support section into contact with a ground pattern provided on a substrate in the case, a jumper wire or the like electrically connected to the ground pattern, or the like.

In the electronic component described in the Patent Document 1, the earth section provided in the support section is always in contact with the ground pattern provided on the substrate in the case, the jumper wire connected to the ground pattern, or the like. Thus, in operating to press the operation buttons, the earth section is strongly pressed against the ground pattern on the substrate or the jumper wire brought into contact with the ground pattern or the like. Therefore, while the pressing operation is repeated many times, it is likely that the ground pattern or the jumper wire is worn or damaged and it is impossible to stably prevent static electricity for a long period of time. Moreover, when the substrate and the earth section rub against each other to form abrasion powder, it is likely that the abrasion powder directly deposits on the substrate to induce electrical troubles such as short-circuit.

### SUMMARY OF THE INVENTION

The invention has been devised in view of the problems described above and it is an object of the invention to provide an electronic apparatus including operation buttons that can surely remove static electricity accumulated in the operation buttons to surely prevent static electricity from being discharged to circuit components and the like in a case from the operation buttons and can prevent an adverse effect on a substrate side mounted with switches.

An electronic apparatus including operation buttons in claim 1 is an electronic apparatus including operation buttons, including: a substrate provided inside a case; switches mounted on the substrate; operation buttons for operating to press the switches from the outside of the case; a conductive chassis provided inside the case; and a button frame provided in the case in order to support the operation buttons, the operation buttons being subjected to surface treatment with a conductive coating layer, characterized in that the operation buttons include: operating sections that project to the outside from through-holes provided in the case; engaging sections that engage with the button frame and hold the operating sections; and elastically-deformable contact pieces integrally formed with the operation buttons to elastically come into contact with the chassis.

According to the constitution in claim 1, the operation buttons and the switches are fixed to the case in a state in which the operation buttons and the switches are separated from each other. When the operating sections are operated to be pressed from this state, the button frame tilts to the switch side, a back of the button frame presses the switches, and ON/OFF of the switches is changed over. In this case, in the operation buttons subjected to surface treatment with the conducive coating layer such as plating, it is likely that static electricity accumulated in the operation buttons is discharged to the switch side. However, since the contact pieces integrally formed with the operation buttons and the chassis are in a conduction state, there is no concern that static electricity is discharged to the switches from the operation buttons.

An electronic apparatus including operation buttons in claim 2 is characterized in that, in the electronic apparatus including operation buttons according to claim 1, the button frame has elastic sections that are elastically deformed by pressing operation of the operating sections, has the operation buttons mounted on front sides of the elastic sections, and has pressing sections for operating to press the switches on backs of the elastic sections, and the elastic sections are elastically deformed by the operation buttons to operate to change over the switches with the pressing sections.

According to the constitution in claim 2, when the operating sections are operated to be pressed, the elastic sections of the button frame are elastically deformed, the button frame tilts to the switch side, the pressing sections formed on the back of the button frame press the switches, and ON/OFF of the switches is changed over. In this case, in the operation buttons subjected to surface treatment with the conducive coating layer, it is likely that static electricity accumulated in the operation buttons is discharged to the switch side. However, since the contact pieces integrally formed with the operation buttons and the chassis are in a conduction state, there is no concern that static electricity is discharged to the switches from the operation buttons.

An electronic apparatus including operation buttons in claim 3 is characterized in that, in the electronic apparatus including operation buttons according to claim 2, at least erected pieces opposed to the contact pieces are bent in the chassis, the contact pieces are brought into contact with the erected pieces in a warped state, and an urging force is always applied to the contact pieces in a direction in which the contact pieces are brought into contact with the erected pieces.

According to the constitution in claim 3, since the contact pieces are brought into contact with the erected pieces in a warped state, the contact pieces and the chassis surely come into contact with each other with an elastic restoring force of the contact pieces.

An electronic apparatus including operation buttons in claim 4 is characterized in that, in the electronic apparatus including operation buttons according to claim 2, fitting holes in which lower ends of the contact pieces are elastically fit in are formed in the chassis.

According to the constitution in claim 4, since the lower end portion of the contact pieces are fit in the fitting holes in a state in which the contact pieces are warped, the contact pieces are brought into contact with inner peripheral surfaces of the fitting holes by an elastic restoring force of the contact pieces and the contact pieces and the chassis surely come into contact with each other.

An electronic apparatus including operation buttons in claim 5 is characterized in that, in the electronic apparatus including operation buttons according to claim 2, at least erected pieces corresponding to the contact pieces are bent in the chassis and pairs of clamping sections that clamp tips of the erected pieces are formed at lower ends of the contact pieces.

According to the constitution in claim 5, since the tips of the erected pieces are clamped by the clamping section formed at the lower ends of the contact pieces, the contact pieces and the chassis surely come into contact with each other.

An electronic apparatus including operation buttons in claim 6 is characterized in that, in the electronic apparatus including operation buttons according to claim 2, the elastic sections are provided in parallel at intervals in the button frame, the contact pieces are integrally formed with the operation buttons mounted on the elastic sections, respectively, an arm piece that integrally couples the contact pieces is formed, and the arm piece is brought into contact with the conductive chassis provided in the case.

According to the constitution in claim 6, the contact pieces of the plural operation buttons are integrated by the arm piece and static electricity accumulated in the plural operation buttons flows to the chassis via the arm piece.

### BRIEF DESCRIPTION OF THE DRAWINGS

FIG. 1 is a sectional view of an electronic apparatus in which a switch is integrated showing a first embodiment of the invention.

FIG. 2 is a disassembled perspective view of operation buttons showing a first embodiment of the invention.

FIG. 3 is a perspective view of an assembled state of the operation buttons showing a first embodiment of the invention.

FIG. 4 is a sectional view of an electronic apparatus in which a switch is integrated indicating a second embodiment of the invention.

FIG. 5 is a sectional view of an electronic apparatus in which a switch is integrated indicating a third embodiment of the invention.

FIG. 6 is a perspective view showing an assembled state of operation buttons indicating a fourth embodiment of the invention.

FIG. 7 is a perspective view showing an assembled state of operation buttons indicating a fifth embodiment of the invention.

### DETAILED DESCRIPTION OF THE PREFERRED EMBODIMENTS

Specific embodiments of the invention will be hereinafter explained with reference to the accompanying drawings. Note that an embodiment mode described below is a mode in embodying the invention and is not meant to limit the invention to a scope of the embodiment mode.

### First Embodiment

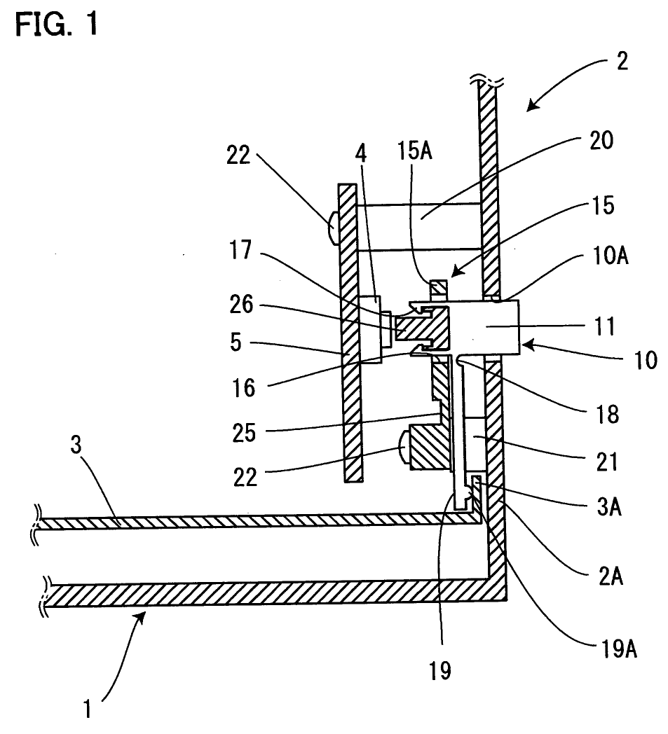

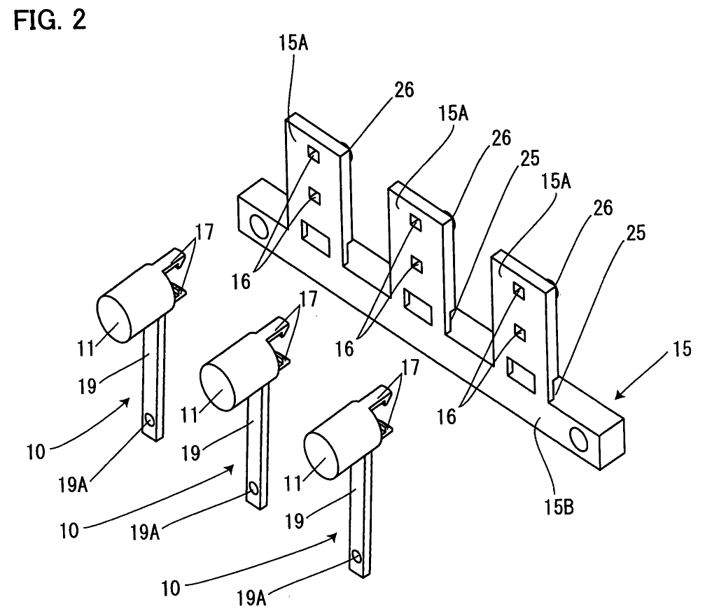

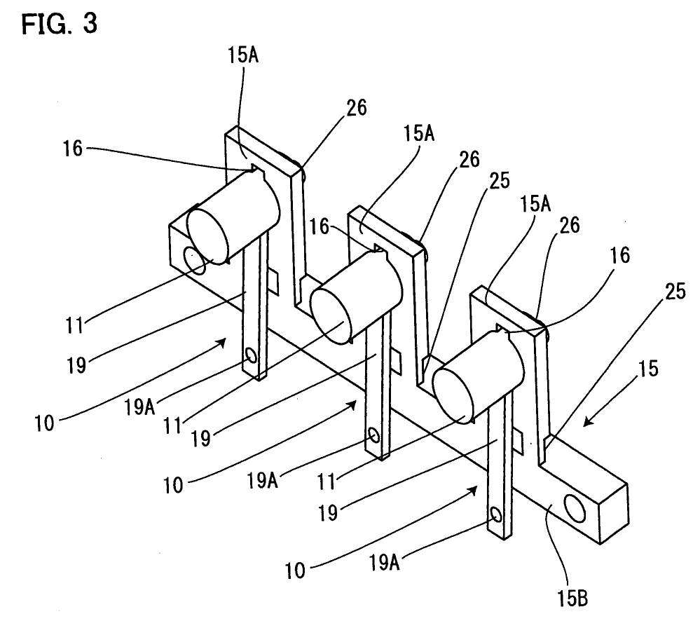

FIGS. 1 to 3 are diagrams showing a first embodiment of the invention. FIG. 1 is a sectional view of an electronic apparatus in which a switch is integrated. FIG. 2 is a disassembled perspective view of operation buttons. FIG. 3 is a perspective view showing an assembled state of the operation buttons. As shown in the figures, a conductive chassis 3 assembled with not-shown various electronic components is fixed inside a case 2 of an electronic apparatus 1. A printed board 5 located on a front side of the case 2 and mounted with a tact switch 4 is also fixed inside the case 2. An operation button 10 for operating the tact switch 4 from the outside of the case 2 is attached to the case 2.

Plural through-holes 10A for attaching the operation button 10 are provided in a front panel 2A of the case 2. Boss sections 20 and 21 are projected near the through-holes 10A on an inner surface side of the front panel 2A. The printed board 5 mounted with the tact switch 4 and a button frame 15 assembled with the operation button 10 are fixed to the boss sections 20 and 21 by screws 22. In this way, the printed board 5 and the button frame 15 fixed to the boss sections 20 and 21 are arranged along the inner surface of the front panel 2A.

The operation button 10 includes plural operating sections 11 operable to be pressed from the outside of the case 2, an engaging hook 17 serving as an engaging section for engaging with engaging holes 16 formed in the button frame 15 to hold the operation button 10 in the button frame 15, and an elastically deformable contact piece 19 integrally formed from the center at a lower end of the operating section 11 via a thin hinge section 18. A projected portion 19A elastically bringing into contact with a chassis 3 is formed at a tip of the contact piece 19. Note that, in this embodiment, an example in which three operation buttons 10 are assembled with the button frame 15 is described. The operation buttons 10 are integrally formed products made of synthetic resin. Surface treatment by a conductive coating layer such as plating is applied to the operation buttons 10.

The button frame 15 has flat elastic sections 15A including the engaging holes 16. The elastic sections 15A are provided in parallel in association with the number of operation buttons 10. In other words, in this embodiment, three elastic sections 15A are provided in parallel. Lower ends of the elastic sections 15A are integrally connected by a connecting section 15B fixed to the boss section 21. The connecting section 15B and the elastic sections 15A are integrally connected via thin hinge sections 25. The button frame 15 is fixed to the boss section 21, which is projected on the inner surface of the front panel 2A, by the screw 22. Consequently, the operating section 11 of the operation button 10 inserted in the engaging holes 16 of the elastic section 15A is projected to the outside of the case 2 from the through-hole 10A formed in the front panel 2A. The elastic section 15A is elastically deformed by the hinge section 25 by operating to press the operating section 11. The tact switch 4 is operated to be pressed by the pressing section 26 projected on a back of the elastic section 15A.

In a state in which the operation button 10 is assembled with the front panel 2A, in the contact piece 19 provided vertically from the lower end of the operating section 11, the projected section 19A provided at the tip of the contact piece 19 is elastically in contact with an erected piece 3A bent from an outer end of the chassis 3 in a state in which the contact piece 19 is slightly warped from the part of the hinge section 18. Consequently, electrical conductivity of the contact piece 19 integrated with the operation button 10 and the conducive chassis 3 is kept.

As shown in FIG. 1, the operation button 10 constituted as described above is fixed to the front panel 2A of the case 2 in a state in which the pressing section 26 and the tact switch 4 are separated from each other. When the operating section 11 is operated to be pressed from this state, the hinge section 25 of the button frame 15 is elastically deformed. The elastic section 15A tilts to the tact switch 4 side around the hinge section 25 according to the elastic deformation of the hinge section 25. According to the tilting, the tact switch 4 is pressed by the pressing section 26 projected on the back of the elastic section 15A and ON/OFF of the tact switch 4 is changed over. In the ON/OFF operation of the tact switch 4, the pressing section 26 of the button frame 15 and the tact switch 4 come into a contacted state. In the operation button 10 subjected to surface treatment by a conductive coating layer such as plating, it is likely that static electricity accumulated in the operation button 10 is discharged to the tact switch 4 side. However, as described above, since the contact piece 19 integrally formed with the operation button 10 and the chassis 3 are in the conduction state, static electricity accumulated in the operation button 10 flows from the contact piece 19. Thus, there is no concern that static electricity is discharged to the tact switch 4 from the operation button 10.

Thereafter, when the finger is released from the operating section 11 to cancel the pressing operation of the operating section 11, the elastic section 15A and the operation button 10 mounted on the elastic section 15A return to initial positions according to an elastic restoring force of the elastic section 15A. The pressing section 26 of the button frame 15 and the tact switch 4 return to the state in which the pressing section 26 and the tact switch 4 are separated from each other.

As described above, according to this embodiment, since the contact piece 19 that comes into contact with the chassis 3 is integrally formed with the operation button 10 subjected to surface treatment by a conductive coating layer such as plating, the operation button 10 and the chassis 3 are in the conduction state. Thus, it is possible to prevent static electricity from accumulating in the operation button 10. Therefore, it is possible to surely prevent static electricity from being discharged to the circuit components such as the tact switch 4 from the operation button 10.

Since the contact piece 19 formed in the operation button 10 is brought into contact with the chassis 3, the printed board 5 and the contact piece 19 do not directly come into contact with each other. Thus, electrical troubles of the printed board 5 caused by damages to and wear of the printed board 5 or formation of abrasion powders due to the wear are never caused according to pressing operation of the operation buttons 10. Consequently, it is possible to stably keep an operation of the tact switch 4 for a long time of period. Since the operation button 10 exposed to the outside of the case 2 and the button frame 15 that fixes the operation button 10 are formed separately, it is possible to reduce manufacturing cost compared with surface treatment by a conductive coating layer such as plating for covering the entire operation button 10 including the button frame 15. It is possible to ensure the contacted state of the contact piece 19 and the chassis 3 using an elastic restoring force of the hinge section 18. Therefore, for example, even if a relative assembly error occurs between the contact piece 19 and the chassis 3, it is possible to absorb the error and surely bring the contact piece 19 and the chassis 3 into contact with each other. In addition, even if the electronic apparatus 1 itself vibrates because of movement or the like, it is possible to maintain the contacted state of the contact piece 19 and the chassis 3.

### Second Embodiment

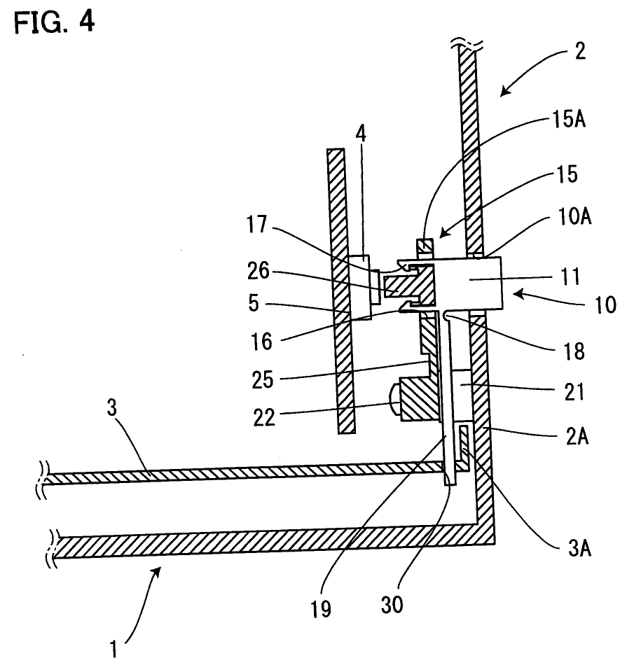

FIG. 4 shows a second embodiment of the invention. Components having the identical functions as those in the first embodiment are denoted by the identical reference numerals and signs.

Explanations of the redundant components are omitted and only different components are explained.

In this embodiment, a fitting hole 30 is formed in the chassis 3 and the contact piece 19 is inserted into the fitting hole 30 to make the contact piece 19 integrally formed with the operation button 10 and the chassis 3 conductive. The contact piece 19 is inserted into the fitting hole 30 in a slightly warped state and is always in contact with an inner peripheral surface of the fitting hole 30 according to an elastic restoring force of the contact piece 19 itself. Consequently, as in the embodiment described above, since the printed board 5 and the contact piece 19 do not directly come into contact with each other, electrical troubles of the printed board 5 caused by damages to and wear of the printed board 5 or formation of abrasion powders due to the wear are never caused according to pressing operation of the operation buttons 10. Consequently, it is possible to stably keep an operation of the tact switch 4 for a long time of period. In addition, it is possible to surely bring the contact piece 19 inserted in the fitting hole 30 into contact with the fitting hole 30 formed in the chassis 3 using an elastic restoring force of the hinge section 18. Since the operation button 10 and the chassis 3 come into a conduction state, it is possible to prevent static electricity from being accumulated in the operation button 10.

### Third Embodiment

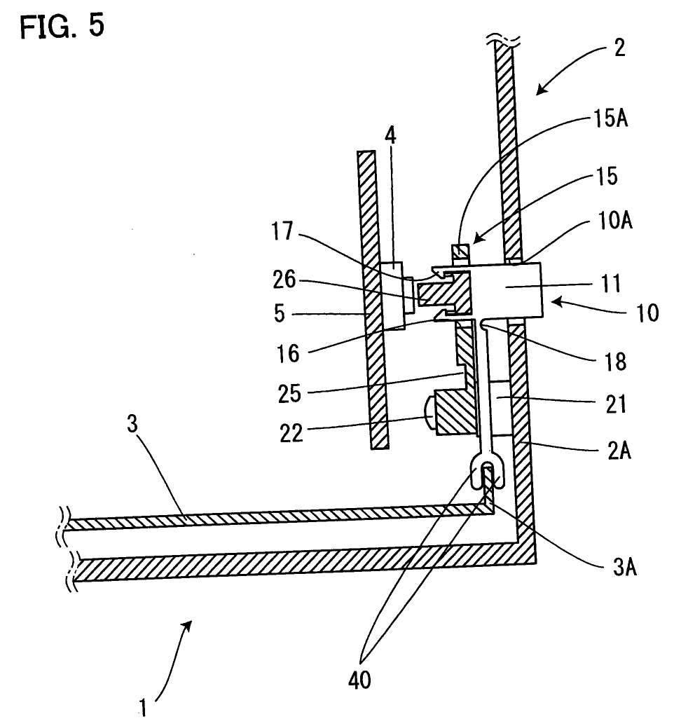

FIG. 5 shows a third embodiment of the invention. Components having the identical functions as those in the embodiments described above are denoted by the identical reference numerals and signs. Explanations of the redundant components are omitted and only different components are explained.

In this embodiment, a U-shaped clamping section 40 is formed at a lower end of the contact piece 19. An upper edge of the erected piece 3A bent from the chassis 3 is clamped by the clamping section 40 to bring the contact piece 19 and the chassis 3 into contact with each other. Since the erected piece 3A of the chassis 3 is clamped by the clamping section 40 formed at the lower end of the contact piece 19 in this way, it is possible to prevent static electricity from being accumulated in the operation button 10 as in the embodiments described above. In addition, electrical troubles of the printed board 5 caused by damages to and wear of the printed board 5 or formation of abrasion powders due to the wear are never caused according to pressing operation of the operation buttons 10. It is possible to surely bring the contact piece 19 and the chassis 3 into contact with each other by clamping the erected piece 3A of the chassis 3 with the clamping unit 40.

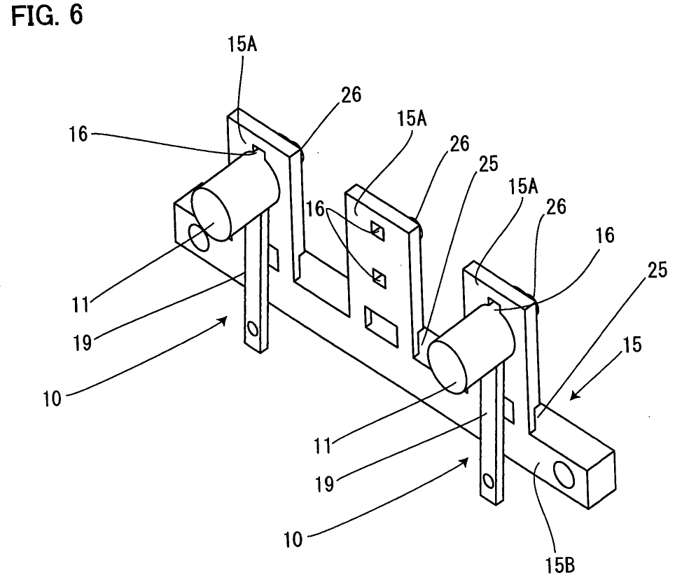

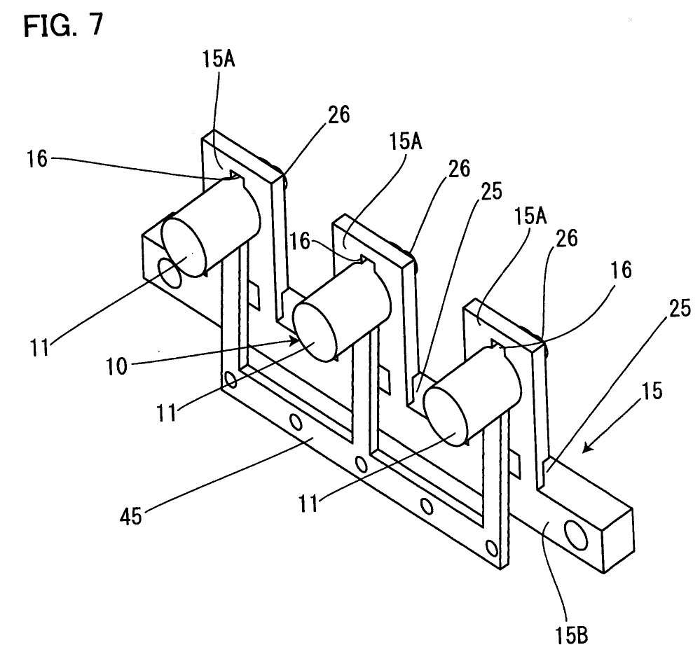

The embodiments of the invention have been described in detail. However, the invention is not limited to the embodiments and various modifications are possible within the scope of the invention. For example, in the embodiments, the operation buttons 10 are assembled with the elastic sections 15A provided in parallel, respectively. However, as shown in a fourth embodiment in FIG. 6, depending on arrangement of the operation buttons 10 integrated in the electronic apparatus 1, it is unnecessary to assemble the operation buttons 10 to all the elastic sections 15A. In addition, as shown in a fifth embodiment in FIG. 7, it is also possible that lower ends of the contact pieces 19 formed in plural operation buttons 10 are integrally connected by an arm piece 45 and the arm piece 45 is brought into contact with the chassis 3. It is possible to integrate the plural operation buttons 10 when the contact pieces 19 are integrated by the arm piece 45 in this way. Thus, it is easy to manage components. In addition, it is possible to assemble the plural operation buttons 10 in the button frame 15 collectively. Thus, the electronic apparatus 1 is excellent in assembling workability. In embodiments, the operation buttons 10 are subjected to plating as an example of surface treatment. However, surface treatment by a conductive coating layer may be applied to the operation buttons 10 according to vapor deposition or the like.

According to the electronic apparatus including operations buttons in claim 1, the electronic apparatus including operation buttons includes: a substrate provided inside a case; switches mounted on the substrate; operation buttons for operating to press the switches from the outside of the case; a conductive chassis provided inside the case; and a button frame provided in the case in order to support the operation buttons. The operation buttons are subjected to surface treatment with a conductive coating layer. The operation buttons include: operating sections that project to the outside from through-holes provided in the case; engaging sections that engage with the button frame and hold the operating sections; and elastically-deformable contact pieces integrally formed with the operation buttons to elastically come into contact with the chassis. Thus, since operation buttons and the chassis are in a conduction state, it is possible to prevent static electricity from being accumulated in the operation buttons. Therefore, it is possible to surely prevent static electricity from being discharged to circuit components such as a tact switch from the operation buttons. Since the contact pieces formed in the operation buttons are brought into contact with the chassis, the substrate and the contact pieces do not directly come into contact with each other. Thus, it is possible to control electrical troubles of the substrate caused by damages to and wear of the substrate or formation of abrasion powders due to the wear involved in pressing operation of the operation buttons. Since the operation buttons exposed to the outside of the case and the button frame that fixes the operation buttons to the case are formed separately, it is possible to reduce manufacturing cost compared with surface treatment by a conductive coating layer such as plating for covering the entire operation buttons including the button frame.

According to the electronic apparatus including operation buttons in claim 2, in the electronic apparatus including operation buttons according to claim 1, the button frame has elastic sections that are elastically deformed by pressing operation of the operating sections, has the operation buttons mounted on front sides of the elastic sections, and has pressing sections for operating to press the switches on backs of the elastic sections, and the elastic sections are elastically deformed by the operation buttons to operate to change over the switches with the pressing sections. Thus, it is possible to surely bring the contact pieces and the chassis into contact with each other using an elastic restoring force of the elastic sections. Therefore, for example, even if a relative assembly error occurs between the contact pieces and the chassis, it is possible to absorb the error and surely bring the contact pieces and the chassis into contact with each other. In addition, even if the electronic apparatus itself vibrates because of movement or the like, it is possible to maintain a contacted state of the contact pieces and the chassis.

According to the electronic apparatus including operation buttons in claim 3, in the electronic apparatus including operation buttons according to claim 2, at least erected pieces opposed to the contact pieces are bent in the chassis, the contact pieces are brought into contact with the erected pieces in a warped state, and an urging force is always applied to the contact pieces in a direction in which the contact pieces are brought into contact with the erected pieces. Thus, it is possible to surely bring the contact pieces and the chassis into contact with each other with an elastic restoring force of the warped contact pieces.

According to the electronic apparatus including operation buttons in claim 4, in the electronic apparatus including operation buttons in claim 2, fitting holes in which lower ends of the contact pieces are elastically fit in are formed in the chassis. Thus, the contact pieces come into contact with inner peripheral surfaces of the fitting holes with an elastic restoring force of the contact pieces. It is possible to surely bring the contact pieces and the chassis into contact with each other.

According to the electronic apparatus including operation buttons in claim 5, in the electronic apparatus including operation buttons according to claim 2, at least erected pieces corresponding to the contact pieces are bent in the chassis and a pair of clamping sections that clamp tips of the erected pieces are formed at lower ends of the contact pieces. Thus, it is possible to surely bring the contact pieces and the chassis into contact with each other by clamping the tips of the erected pieces with the clamping sections formed at the lower ends of the contact pieces.

According to the electronic apparatus including operation buttons in claim 6, in the electronic apparatus including operation buttons according to claim 2, the elastic sections are provided in parallel with the button frame at intervals, the contact pieces are integrally formed with the operation buttons mounted on the elastic sections, respectively, an arm piece that integrally couples the contact pieces is formed, and the arm piece is brought into contact with the conductive chassis provided in the case. Thus, it is possible to feed static electricity accumulated in the operation buttons to the chassis via the arm piece that couples the contact pieces of the plural operation buttons. It is also possible to integrate the plural operation buttons with the arm piece. Thus, it is easy to manage components. In addition, it is possible to assemble the plural operation buttons in the button frame collectively. Thus, the electronic apparatus including operation buttons is excellent in assembling workability.

What is claimed is:

1. An electronic apparatus including operation buttons, comprising: a substrate provided inside a case; switches mounted on the substrate; operation buttons for operating to press the switches from the outside of the case; a conductive chassis provided inside the case; and a button frame provided in the case in order to support the operation buttons, the operation buttons being subjected to surface treatment with a conductive coating layer, characterized in that the operation buttons include: operating sections that project to the outside from through-holes provided in the case; engaging sections that engage with the button frame and hold the operating sections; and elastically-deformable contact pieces integrally formed with the operation buttons to elastically come into contact with the chassis.

2. The electronic apparatus including operation buttons according to claim 1, characterized in that the button frame has elastic sections that are elastically deformed by pressing operation of the operating sections, has the operation buttons mounted on front sides of the elastic sections, and has pressing sections for operating to press the switches on backs of the elastic sections, and the elastic sections are elastically deformed by the operation buttons to operate to change over the switches with the pressing sections.

3. The electronic apparatus including operation buttons according to claim 2, characterized in that at least erected pieces opposed to the contact pieces are bent in the chassis, the contact pieces are brought into contact with the erected pieces in a warped state, and an urging force is always applied to the contact pieces in a direction in which the contact pieces are brought into contact with the erected pieces.

4. The electronic apparatus including operation buttons according to claim 2, characterized in that fitting holes in which lower ends of the contact pieces are elastically fit in are formed in the chassis.

5. The electronic apparatus including operation buttons according to claim 2, characterized in that at least erected pieces corresponding to the contact pieces are bent in the chassis and pairs of clamping sections that clamp tips of the erected pieces are formed at lower ends of the contact pieces.

6. The electronic apparatus including operation buttons according to claim 2, characterized in that the elastic sections are provided in parallel at intervals in the button frame, the contact pieces are integrally formed with the operation buttons mounted on the elastic sections, respectively, an arm piece that integrally couples the contact pieces is formed, and the arm piece is brought into contact with the conductive chassis provided in the case.
